(19) United States
(12) Patent Application Publication
(10) Pub. No.: US 2009/0320082 A1
(43) Pub. Date: Dec. 24, 2009

(54) Method of delivering content data

(75) Inventor: Caesar Collazo, Tarzana, CA (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: iWatchNow Inc., Santa Monica, CA (US)

(21) Appl. No.: 12/214,500

(22) Filed: Jun. 19, 2008

(51) Int. Cl. H04N 7/173

(52) U.S. Cl. 725/105

(57) ABSTRACT

A system and method are provided for delivering video content data from a first computer to a second computer. In such system, a first computer can store video content in first and second encoded video files having first and second data encoding formats. The video content may be stored in a directory accessible by a request from a browser of a second computer. The first computer can receive a request for content data from the second computer and identify a data format consumable a player of the second computer. When the requested content data is available in the consumable data format, the first computer can transmit the requested content data in the consumable data format to the second computer. When the requested content data is available at the first computer but is not in the consumable data format, the first computer may convert the requested content data to the consumable data format and transmit the converted content data having the consumable data format to the second computer.

### BACKGROUND OF THE INVENTION

With the growing availability of broadband communications home and business computer users are increasingly turning to the Internet for access to music, e.g., popular songs and video programs such as television programs, feature films and short films. Increasingly, amateurs and small or less well-known producers distribute their works over the Internet, often through a brand-name website which collects, catalogs and distributes the works to interested users according to their requests.

One of the existing hindrances to distributing works over the Internet is the great variety of formats in which the works can be encoded. Works, especially music and video can be encoded in a variety of mutually incompatible proprietary compressed data formats such as Windows® media player format, Realplayer® format, Quicktime®, Flash®, and MPEG (Moving Picture Experts Group). (Windows® is a registered trademark of Microsoft Corp., Realplayer is a registered trademark of Realnetworks, Inc., Quicktime® is a registered trademark of Apple Inc., and Flash® is a registered trademark of Adobe Systems Inc.). Currently, a user desiring to download and play music or a video from a website must have proprietary player software installed on his computer which matches the format of the downloaded work; i.e., player software which is owned and controlled by a private owner such as Microsoft Corp., Realnetworks, Inc. Apple Inc., Adobe Systems, Inc. or through a consortium of owners such as the Motion Picture Experts Group. The player software includes a decoder able to decode the compressed data from its encoded form. Thus, if the user wishes to download and play a work encoded in the Quicktime format, the Quicktime player needs to be installed and operable on the user's computer. If the user computer only has player software of a different type such as Realplayer, Windows, Flash or MPEG, the user will not able to play the video on his computer, unless the user takes and additional step of obtaining and installing the Quicktime player to the computer.

A problem with this approach is that users can be resistant to installing new player software on their computers. Time must be devoted to seeking out and downloading the player software. Additional time is required to install the player software and determine whether it works as installed. The user may become annoyed and give up on purchasing the music or video through that website, and seek a different distributor instead.

Moreover, even when the user succeeds in obtaining and installing the player software, unexpected problems can crop up, causing delay, annoyance or worse. Sometimes, the user's computer has difficulty operating with newly installed player software due to the characteristics of that computer, especially if the computer is several years old and has an older combination of operating system, microprocessor and memory.

Occasionally, a user's computer can become infected with a contagion after downloading executable software. That is, malicious software such as viruses, worms, Trojans, rootkits, adware, spyware, among others can become installed on and harm a user's computer after receiving data or software over the Internet. A significant percentage of computer users are not properly protected against malicious software and occasionally suffer harm.

Another problem is that, traditionally, each proprietary player does not list all types of recorded music and video works stored on the computer, but instead lists only the works which are encoded in the corresponding proprietary format.

Although compressed video data can be reproduced by player software of the matching type, video content data is sometimes converted from one encoded compressed data format, e.g., Realplayer format, to another compressed data format such as Quicktime. Conventional methods of converting content data from one compressed format to another can be cumbersome. Sometimes, resolution or synchronization of the resulting video can suffer. FIG. 1 illustrates a conventional method of converting video content, e.g., a video program, from one compressed format such as Realplayer to another compressed format such as Quicktime. In block 10, compressed data in the initial (Realplayer) format is accessed from storage, e.g., disk memory, and loaded to a workspace memory of a computer, typically an electronic memory such as a dynamic random access memory (DRAM), static random access memory (SRAM), flash memory, other type of electronic or solid-state magnetoresistive memory or combination thereof. Due to system resource constraints, only a portion of the video content data may be accessed from the storage and processed prior to accessing the next portion and so on.

In block 20, a microprocessor of the computer or co-processor of the computer converts the compressed data from the initial data format to an intermediate compressed data format. For example, the compressed data can be converted to a widely used compressed data format such as an MPEG format. As the computer resources required to convert the video program from one program to another can be quite large, the computer then usually pages the video data that has been converted to the intermediate (MPEG) format to storage (block 30). Subsequently, at least a portion of the video program converted to the intermediate format is accessed from storage (block 40). That data then is converted from the intermediate format to the target format (block 50). Again, only a portion of the video program data may be converted at a time, followed by the next portion, and so on. The target format itself is a compressed data format, but as the target format encodes the video data differently from the intermediate data format, the original resolution of the video program can become degraded and errors can occur in synchronization of the video program as encoded in the target format. The resulting video program in the target format may appear less sharp than the original video program and pictures which follow one another in the video can sometimes appear to overlap each other. The conventional method also places high demands on system resources, especially workspace memory and microprocessor or co-processor resource, particularly since each video program must be converted into compressed data formats twice, once to an intermediate data format, and then from that data format to the target data format.

### SUMMARY

Accordingly, it would be desirable to provide a system for storing and delivering content data, e.g., video content data, from one computer to another, such as for example, via download or peer-to-peer transmission according to a selection by a user of the receiving computer. In accordance with one aspect of the invention, each of the computers can be primarily operated by end-users. Alternatively, either the sending computer or the receiving computer or both can be intended for use by a number of users in the aggregate through a network of computers connected to devices operated by end-users. It would further be desirable for the computer which receives the content data to not be burdened with having to obtain and install player software to match a preexisting data encoding format of the desired audio or music content data. It would further be desirable to make content data available from one computer to another computer in a data format that is readily consumable by the receiving computer without having to store the content data in such data format in advance at the sending computer.

In accordance with an aspect of the invention, a system, a method and a recording medium are provided. Such system may be operable to deliver content data, e.g., including at least one of audio content or video content, from a first computer to a second computer. In such system, a first computer can be operable, to perform tasks, such as, for example, to receive user input at the first computer for identifying first video content and second video content to be made accessible to one or more second computers. First and second video content may be stored as respective first and second encoded files at the first computer. Such files may also be stored in first and second different data encoding formats. The first computer may also then be operable to transmit information which identifies the first and second encoded files to one or more second computers. In response to a request from the second computer for content data contained in at least one of the first and second encoded files, the first computer may be operable to (i) identify a data format consumable by a player residing on the second computer, and (ii) determine whether the requested content data is available at the first computer in the consumable data format. Thus, in one embodiment, the first computer may then determine whether the requested content data is available at the first computer in the consumable data format and, if so, transmit the requested content data in the consumable data format in at least one of the first and second encoded files to the second computer. When the requested content data is available at the first computer but is not in the consumable data format, the first computer then can convert the requested content data to the consumable data format to be stored in a third file and then transmit the third file having the consumable data format to the second computer.

In accordance with another aspect of the invention, a system is provided for delivering content data from a first computer to a second computer. Such system can include, for example, a first computer which is operable to receive user selection input at the first computer selecting a data encoding format. User input can be received at the first computer which identifies video content to be made accessible to one or more second computers. Then, the first computer may determine whether the identified video content is encoded in a data encoding format other than the selected data encoding format. When the identified video content is in the selected data encoding format, then the first computer is operable then to store the identified video content in the selected data encoding format at the first computer. When the identified video content is not in the selected data encoding format, the first computer is operable to encode the identified video content in the selected data encoding format and then store the identified video content in the selected data encoding format at the first computer. Information relating to the identified video content can be transmitted to the second computer, for example, from the first computer. In response to a request from the second computer for the identified video content, the first computer can then be operable to transmit at least a portion of the identified video content to the second computer. In a particular embodiment, the selected data encoding format may be selected from a plurality of mutually incompatible data encoding formats.

### BRIEF DESCRIPTION OF THE DRAWINGS

FIG. 1 is a flow diagram illustrating a prior art method of converting content data between different compressed data formats.

FIG. 2 is a block diagram illustrating a network environment in which an embodiment of the invention can be practiced.

FIG. 3A is a flow diagram illustrating a method of making content data available from a first computer to a second computer in accordance with an embodiment of the invention.

FIG. 3B is a flow diagram illustrating a method of delivering content data in accordance with an embodiment of the invention.

FIG. 4 is a flow diagram illustrating a method of converting content data from one data format to another when rights are available to do so.

FIG. 5 is a block diagram illustrating an alternative network environment in which an embodiment of the invention can be practiced.

FIG. 6 is a flow diagram illustrating a method of converting content data between different compressed data formats in accordance with an embodiment of the invention.

FIG. 7 is a block diagram illustrating an organization of a computer capable of executing a program to perform a method of distributing content data in accordance with an embodiment of the invention.

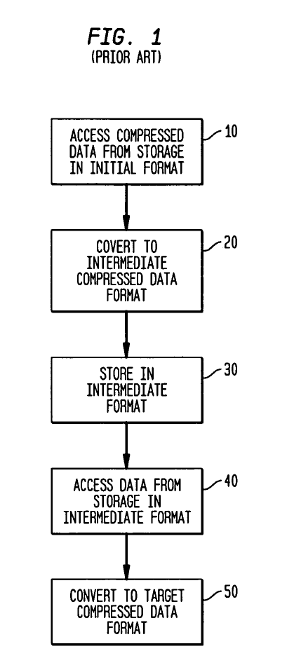

### DETAILED DESCRIPTION

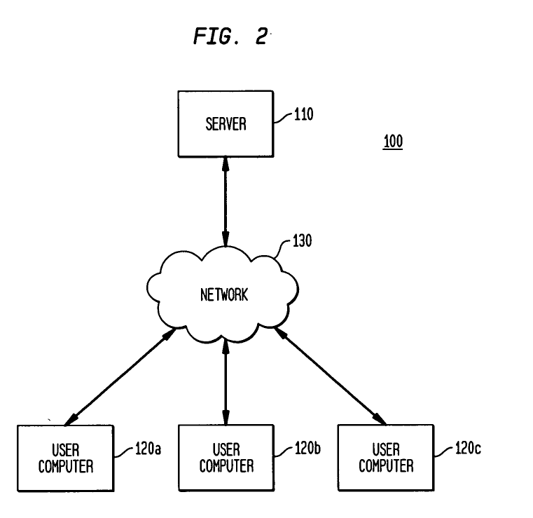

FIG. 2 illustrates a network environment 100 in which a method of distributing content data can be performed according to an embodiment of the invention. As illustrated in FIG. 2, a first computer 110 operates as a server of content data to a plurality of user computers 120a, 120b, and 120c, the user computers being capable of requesting and receiving the content data from the server through a network 130. Each user computer typically includes a desktop, laptop or palmtop (personal digital assistant or “PDA”) device, many types of cellular telephones, or a wearable computer, for example. Media reproduction devices such as music players, game units, video players and the like can also fall within the definition of user computer provided they can be connected directly or indirectly to the network 130 and request and obtain content data from the server 110, e.g., music, videos, executable and non-executable game programs and data, among others. The server computer 110 typically has access to greater resources, e.g., number and type of microprocessors, workspace memory and storage than an individual user computer, and may be connected to other servers or resources which enhance the server's capabilities. However, the server is not required to outperform the user computer. The server can also include a more scaled-down computer such as a desktop computer, laptop computer or portable or handheld computing device or may include one or more computers having any suitable topology for meeting the functional requirement of serving content data to a plurality of user computers. In one embodiment of the invention, the server operates as a micro-webserver which responds to requests in HTTP (hypertext terminal protocol) or S-HTTP (secure hypertext terminal protocol).

Likewise, the network can have any topology suitable for connecting the server computer with the user computers. Thus, the network can include a local area network, wide area network, an enterprise network, an intranet or the Internet, whether wired, wireless, optical or a combination of the foregoing and can include bridges, routers, gateways, trunk lines, and busses. Depending upon the type(s) of communication protocols supported by the computers and the network, connections, usually temporary, may be established between user computers and the server for handling exchanges of information and transmission of content data, especially for downloading music, video, game programs or game data or combination thereof. Content data is data which is usually provided over a network in response to a user's selection of particular data, where the user is given many possible choices of content data from which to choose. Content data generally is not provided by default to users of a network such as the world wide web simply because users click to or display a page of a website. Thus, content data generally is not merely data used to display the parts of a webpage, e.g., the text and images therein, without the user having requested particular data such as music, video, etc. to be provided. Content data may be of a type which an owner, e.g., a record label, television or movie production company, game software producer, etc., has a proprietary interest. Such owner may collect a fee for allowing the content data to be made available over the network. Occasionally, an owner of content data can choose to make the content data free of charge to the public. However, a unit of a government, e.g., a federal agency, local or state government can also provide content data of the type described above even though the government unit may freely provide the content data.

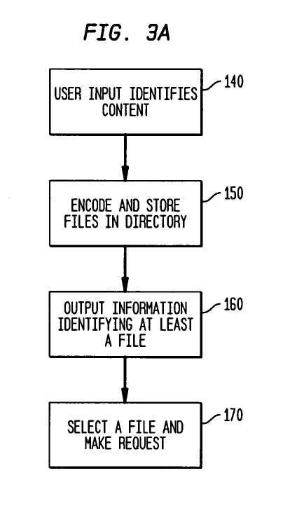

FIG. 3A illustrates steps in a method for making content data available from a first computer to a second computer. Such method can be combined with a method as further described relative to FIG. 3B to deliver content data from the first computer to the second computer. The first and second computers can be both primarily intended for use by individual users. Alternatively, one or both of the computers can be a larger-scale computing device which is not intended for use primarily by an individual. Referring to FIG. 3A, in block 140 a user of a first user computer inputs information identifying video content to be made accessible to a second computer. User input can be provided through a menu-driven interface displayed to the user at the first computer. For example, the user may use a graphical user interface (“GUI”) to input text or select a file such as by highlighting, clicking, dragging and dropping, or otherwise selecting video content to be made available for access to one other computer or more than one other computers.

User input may identify a particular data encoding format in which the video content is to be encoded. In a particular embodiment, user input can be used to select a data encoding format in which the video content is to be encoded when storing and adding video content to a directory of the first computer. User input can be used to establish one or more rules for handling the addition of video content to a directory on the first computer. For example, the user can provide selection input which directs the first computer to store video content in a particular data encoding format to be made accessible via the directory. Then, when video content is added to the directory, the rules check whether the video content is encoded in the user-selected data encoding format. If the video content to be added to the directory is already encoded in the selected format, such video content then is stored in the directory in the selected format. However, when the video content to be added to the directory is not in the selected format, the video content then is encoded into the selected format.

Using the received user input, in block 150 the identified video content is stored in the first computer as a first encoded file in a first data encoding format. The video content may or may not need to be encoded into a particular data encoding format at this time. User input may also be used to identify other video content to be made accessible to one or more other computers. The other video content can be stored in the first computer as a second encoded file in the first data encoding format or a second data encoding format different from the first data encoding format. The data encoding format in which the video content is stored for access via the directory on the first computer can be determined by a particular data encoding format in which the video content is already encoded or by user selection input, or by other means. In a particular embodiment, as described above, a rule established on the first computer may determine which of a plurality of data encoding formats that video content should or is required to be stored on the first computer. Then, the video content may be automatically converted to such selected data encoding format in response to user input directing that video content to be added to the directory of files when the video content is not already in the selected data encoding format.

In a particular embodiment, the user may select the data encoding format in which video content is to be made accessible to other computers through the directory and the user may select the data encoding format from among a plurality of data encoding formats which are mutually incompatible with each other. Stated another way, in such embodiment, the user may select a first data encoding format or a second data encoding format, for example. In such embodiment, a player which is capable of reproducing video content which is encoded in the first data encoding format is incompatible with files encoded in the second data encoding format, such that the particular player is unable to reproduce video content which is encoded in the second data encoding format. Likewise, a player capable of reproducing video content encoded in the second data encoding format may be unable to reproduce video content which is encoded in the first data encoding format.

In one directory of files constructed in accordance with the foregoing, first video content may be stored in a Windows media player data encoding format and second video content may be stored in a Realplayer data encoding format, for example. In addition, one or both such files can be encoded or converted (or re-encoded) into such data encoding format, if necessary. The storing of the first and second encoded files in different formats and indexing of the same in a combined directory of files does not preclude storing a particular piece of video content in multiple data encoding formats, for example, in both Realplayer and Windows media player formats. In addition, multiple different files can be stored in an identical format.

In such manner, a plurality of encoded files can be stored and can be indexed in a directory for later access by the one or more other computers. In one embodiment, the directory of the encoded files can also be accessed by the first computer to determine its contents. The first computer may also utilize or display such directory when adding files to the directory or removing files from the directory.

Subsequently, as illustrated by block 160, information can be provided to the second computer from the first computer which identifies one or more of the encoded files stored in the first computer. For example, the first computer can respond to an HTTP request from a browser of the second computer by serving a page to the second computer which identifies one or more of the encoded video files stored in the first computer. The served page then is displayed at the second computer. The files identified in the displayed page can be a complete set of files as stored on the first computer or can be a subset selected from the complete set based on one or more criteria. For example, a request from a browser of the second computer may be restricted to files having a specific data encoding format or be restricted based on some other criteria such as when stored (the age of the video file), the particular content therein or the running time of the video. In such case, the page served by the first computer is limited to files which match such criteria.

In another case, user input, e.g., in form of a sharing instruction established at the first computer may restrict to whom access is granted to an encoded video file. For example, the user may wish that a particular video file be shared with one or more identified users or groups of users but that such video file not be shared with others. User input can be used to establish a sharing instruction at the first computer which limits to whom the video content can be delivered. In a particular embodiment, such sharing instruction can be established in a secure system using S-HTTP and authentication of users, such as by prompting for and verifying an inputted userid and a password.

Thus, in block 160, through the display of a web-page, for example, information can be conveyed to a user of a second computer which identifies one or more files stored at the first computer which are available and accessible to the user of the first computer. In block 170, the user of the second computer can then select one or more of the files listed on the displayed web-page to be accessed by the second computer, e.g., for reproduction at the second computer or for copying to the second computer.

FIG. 3B illustrates a method of delivering content data over a network according to an embodiment of the invention. In this embodiment, a user computer requests content data and receives the content data in a data format that is compatible with a player installed on the user computer. The user computer is provided the content data in the data format compatible with the user computer, even though initially, the provider does not have the content data in the compatible data format. For example, the requesting user computer can be the above-described second computer which requests a video file for reproduction from the first computer by selecting the video file from a list of encoded video files from a page displayed at the second computer. The embodiment illustrated in FIG. 3B addresses the above-described problem in that content data can be stored in a variety of formats available to a server. User computers need not have installed compatible player software in order to obtain and reproduce content data that the server initially only has available in a noncompatible data format.

Viewing the method from a point of view of a server computer distributing content data, in block 210, the server computer receives a request for content data from another computer such as a user computer. The request may identify a particular piece of content data selected from one or more prompts displayed on a webpage at the user computer. Alternatively, the request may contain information, e.g., search terms, keywords, a category selection and the like, which suffices as a request for particular content data or a class of selected content data. In either case, through the request, the server identifies particular content data to be distributed to the requestor, i.e., the requesting user. In block 220, the server identifies a format of the content data which is consumable by the requestor. Usually, the requestor can consume content data in any format for which it has compatible player software installed. Examples of various types of data formats include: Windows media player, Realplayer, Quicktime, Flash and MPEG. These different data formats are not compatible with each other. When the requestor does not have player software installed which is compatible with the data format of the content data, the requester will not be able to reproduce content data received in that data format. Thus, a user computer which has Quicktime installed thereon but not Realplayer will be able to reproduce content data encoded in Quicktime but cannot reproduce content data encoded in Realplayer format.

The requesting user computer transmits data to the server computer that indicates one or more types of player software installed on the user computer. The requesting user computer normally transmits such data to a server by default when accessing a webpage at a website. From this data, the server identifies one or more data formats which are consumable by the requester. The server may handle this information in form of a list of compatible formats.

In block 230, after identifying a data format or formats which are compatible with the user computer, the server determines whether the requested content data is available in the identified data format. The server may consult a table identifying the various content data available for access by the server and the data formats in which they are encoded. In another example, the server may query a database or another server coupled to the server to determine whether the requested content data is available in the identified data format.

In block 230, the server may determine that the requested content data is not available in the identified format. In such case, when the requested content data is available to the server but in a format different from the identified format, in block 240 the server converts the content data into the identified format. After conversion to the identified format, the content data then is transmitted by the server to the requester (the user computer making the request) (block 250). At the requester, the content data can then be reproduced without requiring different player software to be installed on the requestor (block 260).

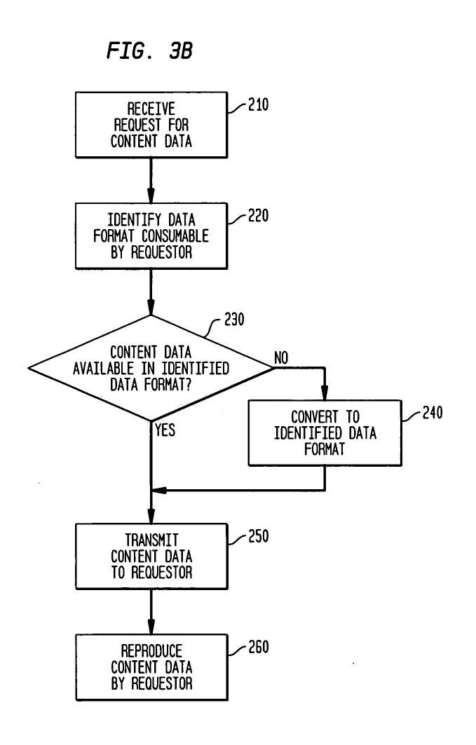

FIG. 4 illustrates a particular method which may be employed when performing the above-described method (FIG. 3) of distributing content data. A converter program may be designed to convert from many data formats to many different data formats. However, proprietary interests in some of the data formats may cause the operator of the server to owe a fee for having a program that converts content data into a particular format. In order to save cost, an operator of a server may decide to obtain rights sufficient to convert content data into certain target data formats, but decide not to obtain rights for converting content data into some other data formats. When rights are available to the server, the server can execute the converter program and convert content data into the identified data format. However, when rights are not available, the converter program cannot be used on the server to convert the content data into the identified data format, even if the converter program has a built-in capability of doing so. Customizing software may prevent the converter program from being used to convert content data into certain identified data formats depending on the rights acquired by a given operator.

Thus in FIG. 4, a method is illustrated for controlling whether content data can be converted into the identified data format depending on whether the server has rights to convert the content data into that format. In block 310, when the server determines that the requested content data is available but not in the identified data format, the server then determines whether rights are available at the server for encoding the requested content data to the identified data format (block 320). Using a list of programs, e.g., player software, obtained from the requestor which identify programs executable by the requester, the server may consult a table to determine what rights are available to it. If the server has rights to convert the data into the identified format, the server proceeds in converting the data into the identified format (block 330). However, when the server does not have rights to convert the content data into the identified data format, the server can post a message to that effect (block 340). For example, the server may return a message to the request when the server does not have rights to encode the content data into an identified format.

The message may simply indicate that the server cannot provide the content data in a data format compatible with player software installed on the requestor. Alternatively, the message may propose a solution to the requestor, such as a way for the requester to obtain rights that will permit the requested content data to be converted, perhaps for a fee. In such case, the requestor at its option can then obtain rights which are usable by the server to encode content data to the identified format on the requestor's behalf. The server may participate in obtaining the rights to be used in this way. Another possibility is that the message may identify a way that player software may be provided to the user computer that is compatible with the requested content data. Alternatively, or in addition thereto, a message can be posted at the server to alert an operator of the server that rights for converting the content data are not available. The message may also be logged such that an operator of the server can monitor such messages and act upon them later, such as by upgrading rights at a later point in time.

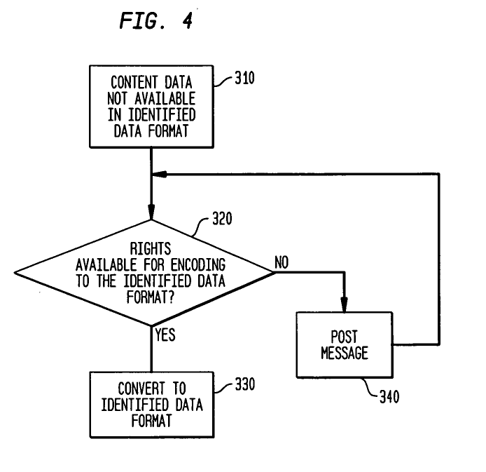

FIG. 5 illustrates an alternative network topology in which a method of distributing content data can be performed according to an embodiment of the invention. In this case, content data can be transferred between individual user computers 410a, 410b, 420a, and 420b, etc., which are attached to a network 430, the network being such as network 130 described above (FIG. 2). Some of the user computers 410a, 410b perform a role of obtaining and reproducing content data, similar to the role played by user computers 120a, 120b, and 120c (FIG. 2). Others of the user computers 420a, 420b may also consume content data but also engage in distributing the content data. Individual users of such computers may enjoy access to a body of content data such as home videos or other self-created works that they desire to share with others. Optionally, some individual users may own copies of music or other works that they no longer want and seek to sell to others, or may be granted limited distribution rights for distributing certain works. As distributors of content data, these user computers have obtained rights of distributing certain types of content data and rights for encoding the content data into certain data formats. For this reason, because of the rights available at these particular user computers 420a, 420b, they can be referred to as “qualified user computers.”

When operating in a mode of distributing works to other user computers, the qualified user computers function in a manner similar to that of the server 110 (FIG. 2) described above. Other user computers 410a, 410b, which do not have rights for distributing and converting content data, obtain and consume content data in a manner such as described above for user computers 120a, 120b, 120c (FIG. 2). The above-described methods of distributing content data and for handling conversion rights (FIGS. 3 and 4) can be performed by computers connected together in a network 400 as shown in FIG. 5.

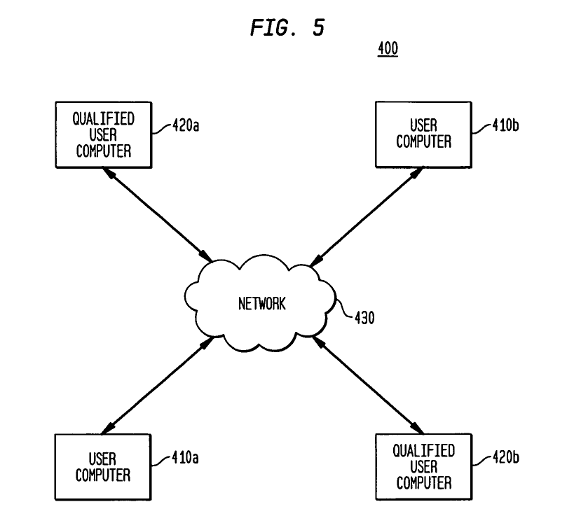

FIG. 6 illustrates a method of converting content data in one compressed data format to a target compressed data format, such as a data format which is compatible with player software of a requestor user computer. FIG. 6 illustrates a method in which content data can be directly converted from one compressed data format such as Quicktime, Realplayer, Flash, etc. to a target compressed data format such as a different one of Quicktime, Realplayer or Flash, without the content data having to be first converted into an intermediate data format such as MPEG. Accordingly in such method, a work having an initial compressed data format, which may include a song, group of songs, a video clip, series of video clips, for example, is accessed from storage (block 510). The work may be loaded into an active workspace memory of a server 110 (FIG. 2) or qualified user computer (420a). In the case of a video clip, in block 520 a processor function of the server then decodes the compressed data into frame data which can be displayable on an electronic display. In the case of an audio work, the work can be decoded into audio data representing an uncompressed audio signal, such as can be processed, amplified and output via a loudspeaker. Subsequently, the frame data or audio data can be converted to a target compressed data format (block 530), for example, a compressed data format which can be consumed by the requestor, for example, a user computer requesting the content data.

Content data is converted from one compressed data format to the identified data format using a particular method in which a part of the requested content data is copied from storage, e.g., a magnetic memory, optical disk memory or magnetic tape to an electronic workspace memory associated with a microprocessor, e.g., a static random access memory (SRAM), dynamic random access memory (DRAM), flash memory or the like. The copied part may contain less than all of the requested content data. For example, when the requested content data is 500 MB (megabytes) in size, the data may be copied into the electronic workspace memory in chunks of 5 or 10 MB each. The microprocessor can then convert one of the copied parts from its existing compressed data format into the identified compressed data format, such as through the method described above with reference to FIG. 6. For example, the data may be converted from a data format such as Quicktime to a Realplayer format.

The converted part of the content data can then be stored temporarily in the electronic workspace memory. The foregoing steps can then be repeated with respect to all of the copied parts of the requested content data until all such parts have been converted to the identified compressed data format. Thereupon, the converted content data can then be transmitted to the requestor for consumption. Alternatively, the server may begin transmitting one or more converted parts of the requested content data before the server finishes converting all parts of the requested content data.

In a particular embodiment, once the content data has been converted from one data format to the identified data format, the converted content data may then be stored again to the storage. In that way a requestor may subsequently obtain the content data in the identified data format without the data again requiring conversion to the identified data format.

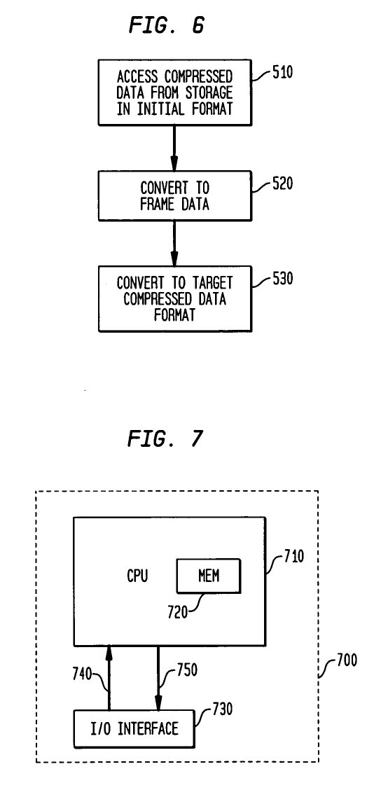

FIG. 7 illustrates a system such as a server computer or qualified user computer according to an embodiment of the invention. As shown in FIG. 7, the system includes a central processing unit (CPU) 710 provided with a memory 720. The CPU 710 may include a single processor or a plurality of processors arranged to execute instructions of a program in a parallel or semi-parallel manner. An input output (I/O) interface 730 is provided for inputting a program including instructions and data to the CPU 710 and for outputting the results of executing a program. The I/O interface 730 preferably includes one or more types of interfaces to removable digital storage media such as a magnetic disk, magneto-optic disk, read/write and/or read only optical disc, digital tape, removable disk drive and/or removable solid state memory such as a portable memory card. In addition to or in place thereof, the I/O interface preferably includes a network interface such as a modem or network adapter card for permitting transfer of information to and from a network. The I/O interface 730 may also include a display for outputting information to and/or inputting information from a user. The I/O interface 730 may additionally include one or more user interface devices such as a keyboard, mouse, speaker, joystick, scanner, printer, etc. and the like. To the extent that any of the above described types of removable storage media are present in the I/O interface, a program containing a set of instructions that is stored in such removable storage medium can be transferred as input 740 between the I/O interface 730 and the CPU 710. In addition to the program, a set of data to be operated upon by the instructions is also input over the I/O interface 730. Once the program and the data set to be operated upon have been loaded into the CPU 710, the CPU then executes the set of instructions of the program relative to the data and provides output 750 to the I/O interface 730 connected thereto.

In an embodiment, a program containing instructions for performing a method according to an embodiment of the invention is stored on one or more removable storage media to be provided to the I/O interface 730 and loaded into the CPU 710. Alternatively, the program containing the instructions is transferred from a storage medium such as a memory of one or more computers or other storage devices of a network to a modem, network adapter or other device of the I/O interface 730 and further transferred therefrom to the CPU 710. After the CPU 710 receives and loads the program into memory, the program is then executed relative to the set of data provided to the CPU 710. In such way, the foregoing methods of distributing content data can be performed by a server computer or other computer, e.g., qualified user computer executing a program loaded thereon

As these and other variations and combinations of the features discussed above can be utilized, the foregoing description of the preferred embodiments should be taken by way of illustration, rather than by limitation of the invention, as defined by the claims.

1. A system for delivering content data including at least one of audio content or video content from a first computer to a second computer, comprising:
a first computer operable to
a) receive user input at the first computer for identifying first video content and second video content to be made accessible to the second computer;
b) store the first and second video content as respective first and second encoded files at the first computer, the first and second encoded files having first and second different data encoding formats;
c) transmit information identifying the first and second encoded files to the second computer; and
d) in response to a request from the second computer for content data contained in at least one of the first and second encoded files, the first computer is operable to (i) identify a data format consumable by a player residing on the second computer, and (ii) determine whether the requested content data is available at the first computer in the consumable data format, and when the requested content data is available at the first computer in the consumable data format, transmit the requested content data in the consumable data format in at least one of the first and second encoded files to the second computer, and when the requested content data is available at the first computer but is not in the consumable data format, convert the requested content data to the consumable data format to be stored in a third file and transmit the third file having the consumable data format to the second computer.

2. The system as claimed in claim 1, wherein the encoded files are stored in a directory accessible via a request from a browser of the second computer.

3. The system as claimed in claim 2, wherein the directory is accessible via a hypertext terminal protocol (“HTTP”) request.

4. The system as claimed in claim 2, wherein the encoded files are stored in a directory accessible via a secure hypertext terminal protocol (“HTTPS”) request.

5. The system as claimed in claim 4, wherein the first computer is operable to receive user input including a sharing instruction for the at least one of the first and second video content and is operable to restrict the transmission of the requested content data in accordance with the sharing instruction.

6. The system as claimed in claim 5, wherein the first computer is operable to control access to the directory by at least authenticating the user of the second computer.

7. The system as claimed in claim 1, wherein the first and second encoded files are encoded respectively in first and second proprietary data formats owned by respective first and second different entities.

8. A method of delivering content data including at least one of audio content or video content from a first computer to a second computer, the method comprising executing at least one program at the first computer to perform steps including:
a) receiving user input at the first computer for identifying first video content and second video content to be made accessible to the second computer;
b) storing the first and second video content as respective first and second encoded files at the first computer, the first and second encoded files having first and second different data encoding formats;
c) transmitting information identifying the first and second encoded files to the second computer; and
d) in response to a request from the second computer for content data contained in at least one of the first and second encoded files, (i) identifying a data format consumable by a player residing on the second computer, and (ii) determining whether the requested content data is available at the first computer in the consumable data format, and when the requested content data is available at the first computer in the consumable data format, transmitting the requested content data in the consumable data format in at least one of the first and second encoded files to the second computer, and when the requested content data is available at the first computer but is not in the consumable data format, converting the requested content data to the consumable data format to be stored in a third file and transmitting the third file having the consumable data format to the second computer.

9. The method as claimed in claim 8, wherein the encoded files are stored in a directory accessible via a request from a browser of the second computer.

10. The method as claimed in claim 9, wherein the directory is accessible via a hypertext terminal protocol (“HTTP”) request.

11. The method as claimed in claim 9, wherein the encoded files are stored in a directory accessible via a secure hypertext terminal protocol (“HTTPS”) request.

12. The method as claimed in claim 11, wherein step (a) includes receiving user input including a sharing instruction for the at least one of the first and second video content and restricting the transmission of the requested content data in step (c) in accordance with the sharing instruction.

13. The method as claimed in claim 13, wherein step (d) further includes controlling access to the directory by at least authenticating the user of the second computer.

14. The method as claimed in claim 14, further comprising, prior to step (b) encoding the first video content and second video content respectively in first and second proprietary data formats owned by respective first and second different entities.

15. A recording medium having computer-readable instructions recorded thereon, the instructions being executable by a first computer to perform a method of delivering content data from a first computer to a second computer, the method comprising:
a) receiving user input at the first computer for identifying first video content and second video content to be made accessible to the second computer;
b) storing the first and second video content as respective first and second encoded files at the first computer, the first and second encoded files having first and second different data encoding formats;
c) transmitting information identifying the first and second encoded files to the second computer; and
d) in response to a request from the second computer for content data contained in at least one of the first and second encoded files, (i) identifying a data format consumable by a player residing on the second computer, and (ii) determining whether the requested content data is available at the first computer in the consumable data format, and when the requested content data is available at the first computer in the consumable data format, transmitting the requested content data in the consumable data format in at least one of the first and second encoded files to the second computer, and when the requested content data is available at the first computer but is not in the consumable data format, converting the requested content data to the consumable data format to be stored in a third file and transmitting the third file having the consumable data format to the second computer.

16. The recording medium as claimed in claim 15, wherein the encoded files are stored in a directory accessible via a request from a browser of the second computer.

17. The recording medium as claimed in claim 16, wherein the directory is accessible via a hypertext terminal protocol (“HTTP”) request.

18. The recording medium as claimed in claim 16, wherein the encoded files are stored in a directory accessible via a secure hypertext terminal protocol (“HTTPS”) request.

19. The recording medium as claimed in claim 18, wherein step (a) includes receiving user input including a sharing instruction for the at least one of the first and second video content and restricting the transmission of the requested content data in step (c) in accordance with the sharing instruction.

20. The recording medium as claimed in claim 19, wherein step (d) further includes controlling access to the directory by at least authenticating the user of the second computer.

21. The recording medium as claimed in claim 15, wherein the method further comprises, prior to step (b) encoding the first video content and second video content respectively in first and second proprietary data formats owned by respective first and second different entities.

22. A method of distributing video content from a first user computer to at least one second user computer, comprising:
accepting user input through a menu-driven interface at a first user computer for identifying first video content and second video content to be shared;
accepting user input through the menu-driven interface for identifying a first one of a plurality of available data encoding formats for encoding the first video content and identifying a second one of the plurality of available data encoding formats for encoding the second video content;
encoding and storing the first and second video content in respective files at the first user computer in a directory accessible via a hypertext terminal protocol (“HTTP”), the files having the first and second data encoding formats, respectively;
serving a page identifying at least one of the first or second stored encoded video content files to a second user computer in response to an HTTP request from the second user computer to the first computer; and
serving at least one of the first or second stored encoded video content files in response to a request made by the second user computer using the served page,
wherein when the requested encoded video content file is available in a data format consumable by the second computer, transmitting the requested content data in the consumable data format to the second computer, and when the requested content data is available at the first computer but is not in the consumable data format, converting the requested content data to the consumable data format and transmitting the converted content data in the consumable data format to the second computer.

23. A system for delivering content data from a first computer to a second computer, comprising:
a first computer operable to
a) receive user selection input at the first computer selecting a data encoding format;
b) receive user input at the first computer identifying video content to be made accessible to the second computer;
c) determine whether the identified video content is encoded in a data encoding format other than the selected data encoding format, and when the identified video content is in the selected data encoding format, then the first computer is operable then to store the identified video content in the selected data encoding format at the first computer, and when the identified video content is not in the selected data encoding format, the first computer is operable to encode the identified video content in the selected data encoding format and then store the identified video content in the selected data encoding format at the first computer;
d) transmit information relating to the identified video content to the second computer; and
e) in response to a request from the second computer for the identified video content, the first computer is operable to transmit at least a portion of the identified video content to the second computer.

24. The system for delivering content data as claimed in claim 23, wherein the selected data encoding format is selected from a plurality of mutually incompatible data encoding formats.
